(19) United States
(12) Patent Application Publication
(10) Pub. No.: US 2019/0173558 A1
(43) Pub. Date: Jun. 6, 2019

(54) WIRELESS COMMUNICATION APPARATUS, WIRELESS COMMUNICATION SYSTEM, AND BEAM SEARCH SIGNAL TRANSMISSION METHOD

(71) Applicant: FUJITSU LIMITED, Kawasaki-shi (JP)

(72) Inventors: Kenichi NISHIKAWA, Kawasaki (JP); Masahiko Shimizu, Kawasaki (JP)

(73) Assignee: FUJITSU LIMITED, Kawasaki-shi (JP)

(21) Appl. No.: 16/203,561

(22) Filed: Nov. 28, 2018

(30) Foreign Application Priority Data
Dec. 1, 2017 (JP) 2017-231885

(51) Int. Cl. H04B 7/06; H04B 7/0408; H04W 16/28; H04W 72/04; H04W 88/08

(52) U.S. Cl. CPC H04B 7/0695; H04B 7/0408; H04B 7/0617; H04W 88/08; H04W 16/28; H04W 72/046; H04B 7/0634

(57) ABSTRACT

A wireless communication apparatus includes a memory, and a processor coupled to the memory and configured to determine a number of transmissions of beam search signal for performing a beam search in an area where the beam search is performed, and determine a combination of the area and a presence/absence of the beam search signal according to the determined number of transmissions of beam search signal, based on a number of areas where the beam search is performed and a number of beams formed in the area by a transmission time of the beam search signal by the wireless communication apparatus, and generate the beam search signal to be transmitted to another wireless communication apparatus according to the determined combination.

### CROSS-REFERENCE TO RELATED APPLICATION

This application is based upon and claims the benefit of priority of the prior Japanese Patent Application No. 2017-231885, filed on Dec. 1, 2017, the entire contents of which are incorporated herein by reference.

### FIELD

The embodiments discussed herein are related to a wireless communication apparatus, a wireless communication system, and a beam search signal transmission method.

### BACKGROUND

A communication standardization body, called 3GPP (3rd Generation Partnership Project), is currently considering the 5th generation mobile communication (hereinafter, sometimes referred to as “5G”) as the next generation wireless communication system technology. In the 5G, a continued development of an LTE (Long Term Evolution) system and an LTE-Advanced system, or, for example, a new RAT (Radio Access Technology) (it is called NR: New Radio) that supports a broadband using higher frequency bands than ever have been used are being considered.

In such a wireless communication system, a signal processing technique such as the beamforming may be performed in some cases. The beamforming is, for example, a technique in which a base station apparatus transmits or receives a wireless signal with an increased radio wave directionality for a predetermined direction. The base station apparatus transmits a beam search signal during a search period, and a terminal device performs a beam search based on the beam search signal and feeds back a result of the beam search to the base station apparatus. Based on the fed back result, the base station apparatus may be able to perform the beamforming to transmit data to the terminal device or receive data transmitted from the terminal device. In this way, by using the beamforming technique, it becomes possible for the base station apparatus to transmit a wireless signal in a direction in which the terminal device exists, or receive a wireless signal transmitted from the terminal device in the direction in which the terminal device exists.

As one of techniques related to such a wireless communication system, there is a technique in which a transmitter transmits plural signals each having a beam in each of directions selected from plural different directions and a receiver determines whether each of plural received signals satisfies a predetermined condition. In addition, there is a wireless communication system that selects a direction which is closest to the direction from the transmitter to the receiver, among the plural directions, based on a result of the determination.

According to this technique, it is possible to quickly select a direction which is closest to the direction from a transmitter to a receiver, among plural directions.

Related techniques are disclosed in, for example, Japanese Laid-open Patent Publication No. 2017-108230.

### SUMMARY

According to an aspect of the embodiments, a wireless communication apparatus includes a memory, and a processor coupled to the memory and configured to determine a number of transmissions of beam search signal for performing a beam search in an area where the beam search is performed, and determine a combination of the area and a presence/absence of the beam search signal according to the determined number of transmissions of beam search signal, based on a number of areas where the beam search is performed and a number of beams formed in the area by a transmission time of the beam search signal by the wireless communication apparatus, and generate the beam search signal to be transmitted to another wireless communication apparatus according to the determined combination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration example of a communication system;

FIG. 2 is a view illustrating a configuration example of a base station apparatus;

FIG. 3 is a view illustrating a configuration example of a terminal device;

FIGS. 4A to 4C are views illustrating examples of a beam, and FIG. 4D is a view illustrating an example of transmission/non-transmission of a search signal;

FIG. 5A is a view illustrating an example of a hardware configuration of a base station apparatus, and FIG. 5B is a view illustrating an example of a hardware configuration of a terminal device;

FIG. 6 is a flowchart illustrating an operation example of a base station apparatus;

FIG. 7 is a view illustrating a combination example of an area and the presence/absence of a search signal;

FIG. 8 is a view illustrating an example of the number of combinations of beams;

FIGS. 9A to 9C are views illustrating combination examples of an area and the presence/absence of a beam;

FIG. 10 is a view illustrating a combination example of an area and the presence/absence of a search signal;

FIG. 11 is a view illustrating a combination example of an area and the presence/absence of a search signal;

FIG. 12 is a view illustrating a combination example of an area and the presence/absence of a search signal;

FIG. 13 is a view illustrating a combination example of an area and the presence/absence of a search signal;

FIG. 14 is a view illustrating a combination example of an area and the presence/absence of a search signal;

FIG. 15 is a view illustrating a combination example of an area and the presence/absence of a search signal;

FIGS. 16A to 16F are views illustrating examples of a beam; and

FIGS. 17A to 17C are views illustrating combination examples of an area and the presence/absence of a search signal.

### DESCRIPTION OF EMBODIMENTS

The above-described technique for selecting a direction which is closest to the direction from a transmitter to a receiver does not consider making a signal having a beam to reach a terminal device located in a service-area end of a base station apparatus.

Therefore, according to the above-described technique, the terminal device may not receive the signal having the beam, or may not accurately measure the direction of the beam through a beam search since a reception level is relatively small even when the signal having the beam is received. In this case, the base station apparatus may not accurately direct the beam to the direction in which the terminal device is present even when the beamforming is performed based on the fed-back information. Therefore, the terminal device may not receive data transmitted from the base station apparatus, which may result in a throughput lower than the original throughput.

Hereinafter, descriptions will be given of embodiments of a technique capable of delivering a beam to a terminal device located in a service-area end of a base station apparatus. The following embodiments do not limit the disclosed techniques. The disclosed embodiments may be used in proper combination as long as the processing contents are not inconsistent with each other. In addition, the terms and technical contents described in the present disclosure may be appropriately used with terms and technical contents described in the specifications as the standards such as 3GPP (Third Generation Partnership Project).

### First Embodiment

### Configuration Example of Wireless Communication System

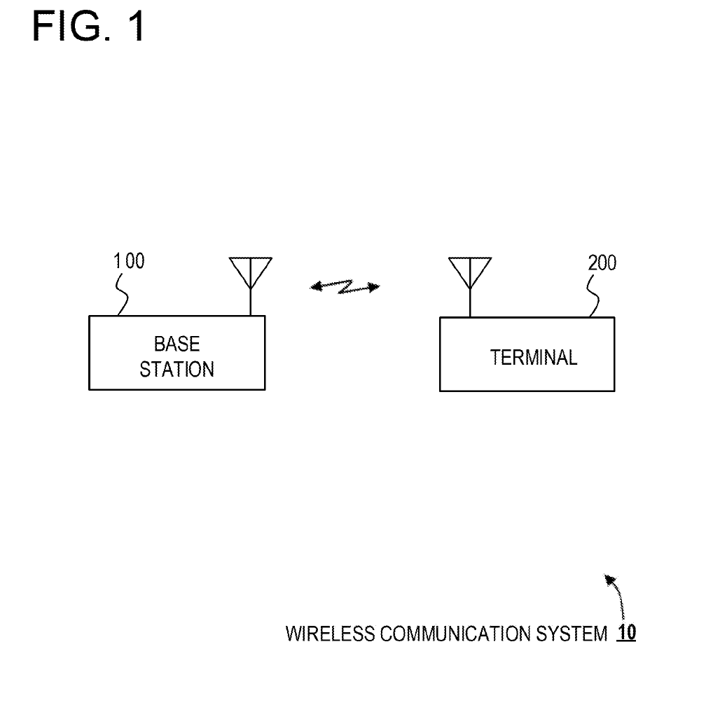

FIG. 1 is a view illustrating a configuration example of a wireless communication system 10 according to a first embodiment.

The wireless communication system 10 includes a base station apparatus (hereinafter, sometimes referred to as a “base station”) 100 and a terminal device (hereinafter, sometimes referred to as a “terminal”) 200.

The base station 100 is, for example, a wireless communication apparatus capable of wirelessly communicating with the terminal 200. The base station 100 may provide various services such as a call service and a web browsing service to a terminal 200 located in its own service available range (or cell range).

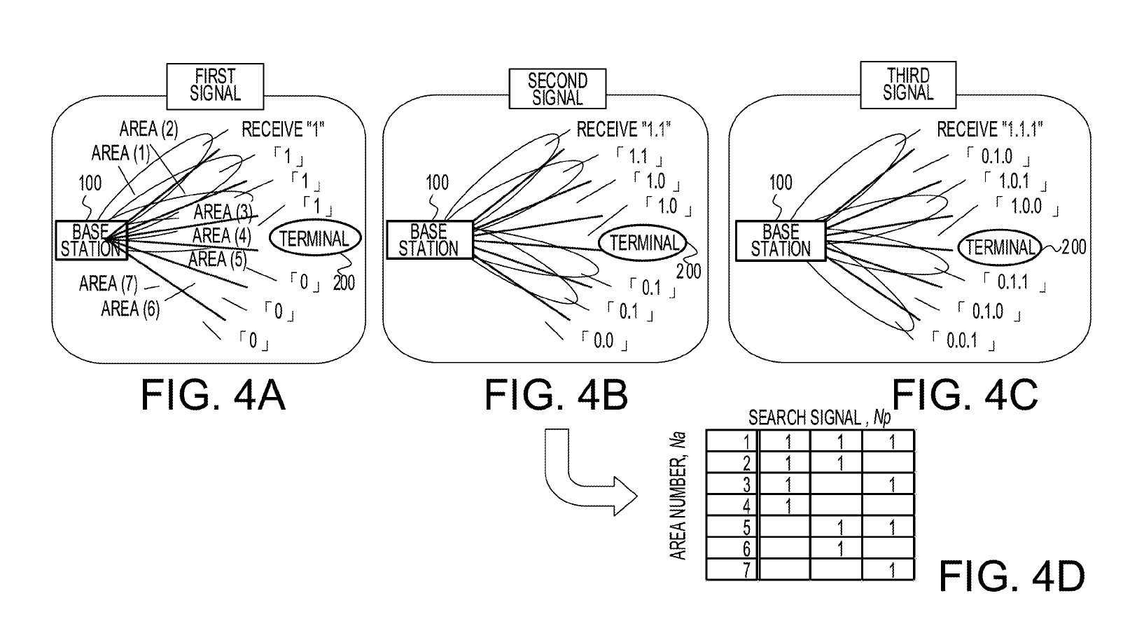

In the first embodiment, the base station 100 performs a beamforming and transmits a beam search signal (hereinafter, sometimes referred to as a “search signal”) to the terminal 200. For example, one beam is formed by one or more search signals. The base station 100 forms a beam while changing the combination of beam directions formed by one time transmission of search signals at each time. For example, there are plural beam directions formed by one time transmission of search signals. When a beam formed by one time transmission of search signals is directed in multiple directions, such a beam may sometimes be referred to as a multi-beam. FIG. 4A, for example, illustrates an example of a multi-beam, and the details thereof will be described by way of an example of operation.

The terminal 200 is, for example, a wireless communication device capable of wirelessly communicating with the base station 100. The terminal 200 is, for example, a smartphone, a feature phone, a tablet terminal, a game device, a clock device, and so on, which are capable of wireless communication.

In the first embodiment, the terminal 200 receives a search signal transmitted from the base station 100 and performs a beam search using the received search signal. The terminal 200 may determine (or measure) its own (terminal 200) direction relative to the base station 100 by the beam search. The terminal 200 feeds back a result of the determination to the base station 100. Then, based on the determination result, the base station 100 estimates the direction of the terminal 200, performs beamforming toward that direction, and transmits data to the terminal 200 or receives data transmitted from the terminal 200. Details of the process will be described by way of an example of operation.

In the example of FIG. 1, one terminal 200 is connected to one base station 100, but plural terminals 200 may be connected to the base station 100.

### Configuration Example of Base Station Apparatus

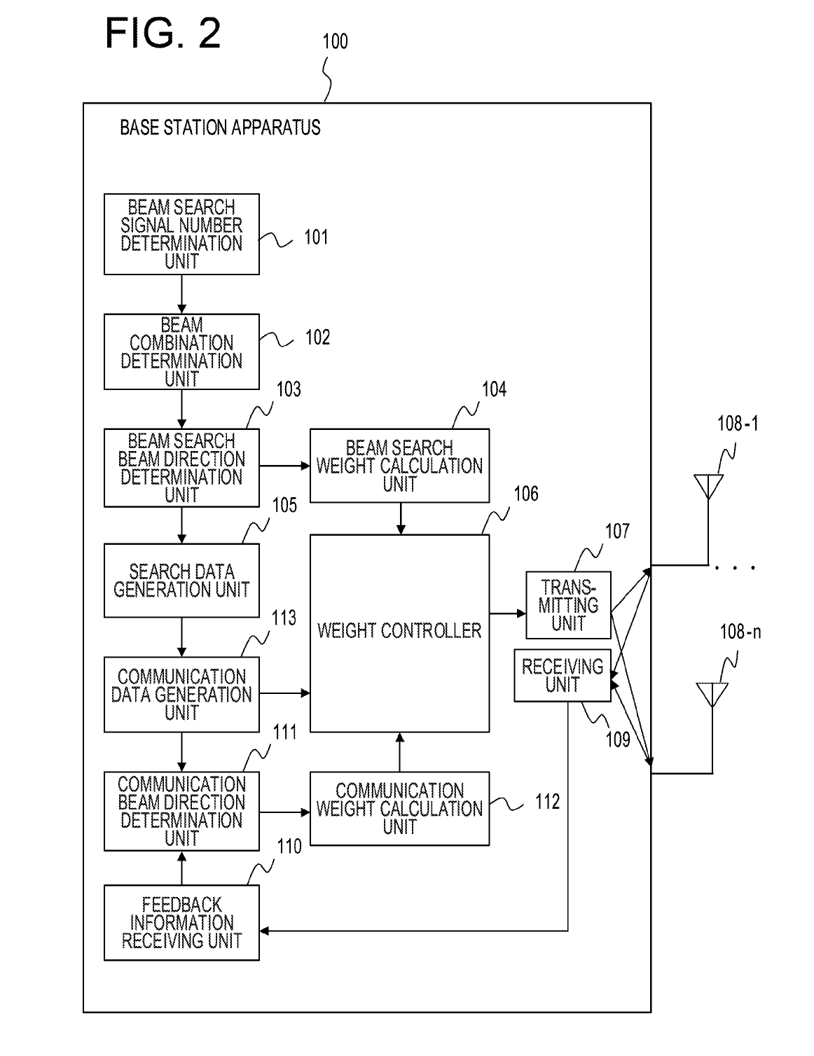

FIG. 2 is a view illustrating a configuration example of the base station 100.

The base station 100 includes a beam search signal number determination unit 101, a beam combination determination unit 102, a beam search beam direction determination unit 103, a beam search weight calculation unit 104, a search data generation unit 105, a weight controller 106, and a transmitting unit 107. In addition, the base station 100 includes plural antennas (or antenna elements) 108-1 to 108-n (n is an integer of 2 or more), a receiving unit 109, a feedback information receiving unit 110, a communication beam direction determination unit 111, a communication weight calculation unit 112, and a communication data generation unit 113.

The beam search signal number determination unit (hereinafter, sometimes referred to as a “search signal number determination unit”) 101 determines the minimum value of the number of transmissions based on the number of areas where a beam search is performed and the number of beams formed by one time transmission of search signals by the base station 100. The minimum value of the number of transmissions is, for example, the minimum value of the number of transmissions of search signals for beam search in all areas. The number of areas, the number of beams, and the number of transmissions will be described below.

FIGS. 4A to 4C are views illustrating examples of a beam formed by the base station 100. In the examples of FIGS. 4A to 4C, there are seven areas from area (1) to area (7).

FIG. 4A illustrates an example in which the base station 100 transmits four search signals to area (1), area (2), area (3), and area (4), respectively, with one time transmission of search signals, to form four beams, respectively. FIG. 4B illustrates an example in which the base station 100 forms four beams in area (1), area (2), area (5), and area (6), respectively. FIG. 4C illustrates an example in which the base station 100 forms four beams in area (1), area (3), area (5), and area (7), respectively.

In the following description, it is assumed that one beam is formed by one search signal.

For example, the base station 100 sequentially transmits a “1st signal”, a “2nd signal”, and a “3rd signal” illustrated in FIGS. 4A to 4C, respectively. Then, for example, the terminal 200 determines the case as “1” when a search signal transmitted by a beam may be normally received, and determines the case as “0” when the search signal transmitted by the beam may not be normally received. For example, the terminal 200 which has normally received a search signal determines the case as “100” when the search signal is located in the area (4), and determines the case as “111” when the search signal is located in the area (1). The terminal 200 feeds back a result of the determination to the base station 100. Based on the determination result, the base station 100 determines an area in which the terminal 200 is located, performs the beamforming, and transmits data toward that direction.

FIG. 4D is a view illustrating a combination example of an area and the presence/absence of transmission of a search signal. FIG. 4D is a table that summarizes the transmissions of search signals for the areas from FIG. 4A to FIG. 4C. Assuming that the number of areas is Na and the minimum value of the number of t transmissions of search signals is Np, FIG. 4D illustrates a combination example of beams at Na=7 and Np=3.

In FIG. 4D, the number of beams formed by the first transmission of the search signal is “4”, and the number of beams formed in the second and third transmissions of the search signal is also “4”. The number of beams formed by the first transmission of the search signal is denoted by Nb.

In the first embodiment, the search signal number determination unit 101 determines the minimum value Np of the number of times of search signal transmission in consideration of not only the number of areas Na but also the number of beams Nb formed by one time transmission of the search signal, details of which will be described by way of an example of operation.

Then, the search signal number determination unit 101 determines a combination of an area and the presence/absence of transmission of the search signal by the minimum value Np. FIG. 4D illustrates an example of the combination. The search signal number determination unit 101 outputs information on the determined combination (e.g., “111” for the area number “1”, “110” for the area number “2”) to the beam combination determination unit 102.

Referring back to FIG. 2, the beam combination determination unit 102 allocates a combination to each area based on the information on the combination to allocate the presence/absence of transmission of a search signal to an actual area where the beam search is performed. For example, in the example of FIG. 4D, the beam combination determination unit 102 allocates the area (1) in FIG. 4A for the area number “1” and allocates the beam combination “111” to the area (1). The beam combination determination unit 102 outputs the allocation information (e.g., “111” for the area (1), and “110” for the area (2)), which indicates the presence/absence of transmission of the search signal allocated to each area, to the beam search beam direction determination unit 103.

The beam search beam direction determination unit (hereinafter, sometimes referred to as a “search beam direction determination unit”) 103 determines a beam search direction according to the allocation information. For example, the search beam direction determination unit 103 sets the angle of a search signal to be transmitted from the base station 100 to the area (4) as the reference angle “0°” in FIG. 4A, and determines an angle at which the search signal is to be transmitted, relative to the reference angle. This reference angle is not limited to 0° but may be an arbitrary angle. For example, the search beam direction determination unit 103 outputs the determined beam search direction (e.g., “111” at 30° for the area (1), and “110” at 25° for the area (2)) to the beam search weight calculation unit 104.

Referring back to FIG. 2, the beam search weight calculation unit (hereinafter, sometimes referred to as a “search weight calculation unit”) 104 calculates a weight value (or a weighting value) for beam search data output from the search data generation unit 105, according to the beam search direction. For example, the weight value corresponds to the direction of the search signal transmitted to each area. For example, the search weight calculation unit 104 may read out, from an internal memory, a matrix closest to the combination of angles with respect to one or more search signals transmitted in one time transmission (which may be, e.g., a pre-coding matrix). The search weight calculation unit 104 outputs the calculated weight value to the weight controller 106.

The search data generation unit 105 generates beam search data and outputs the generated data to the weight controller 106.

The weight controller 106 applies a weight (e.g., perform a weight application) in the beam search data according to the weight value received from, for example, the search weight calculation unit 104. By applying a weight on the beam search data, the weight controller 106 may transmit the beam search data with its controlled phase from each of the antenna elements 108-1 to 108-n. The weight controller 106 outputs the weighted (or phase-controlled) beam search data to the transmitting unit 107.

The transmitting unit 107 converts (up-converts) the beam search data into a wireless signal in a wireless band. For this reason, the transmitting unit 107 may include, for example, a D/A (Digital to Analogue) conversion circuit and a frequency conversion circuit. The transmitting unit 107 outputs the obtained wireless signal to the antennas 108-1 to 108-n as a search signal.

The antennas 108-1 to 108-n transmit the search signal to the terminal 200. Since the search signal is weighted, the antennas 108-1 to 108-n may transmit the search signal in a predetermined direction.

The antennas 108-1 to 108-n receive the wireless signal transmitted from the terminal 200 and output the received wireless signal to the receiving unit 109.

The receiving unit 109 converts (down-converts) the wireless signal into a baseband signal in a baseband and extracts feedback information from the baseband signal. The receiving unit 109 outputs the extracted feedback information to the feedback information receiving unit 110.

The feedback information receiving unit 110 receives the feedback information transmitted from the terminal 200. The feedback information is, for example, information indicating a result of the beam search in the terminal 200 and is information indicating a result of determination as to whether a search signal has been received. The feedback information receiving unit 110 outputs the feedback information to the communication beam direction determination unit 111.

The communication beam direction determination unit 111 determines the direction of a communication beam based on the feedback information. For example, in the example of FIG. 4D, when obtaining the feedback information of “111”, the communication beam direction determination unit 111 determines that the direction of the area (1) in FIG. 4A is the direction of the communication beam. The communication beam direction determination unit 111 outputs the determined communication beam direction to the communication weight calculation unit 112.

Referring back to FIG. 2, the communication weight calculation unit 112 calculates a weight value (or a weighting value) for communication data according to the communication beam direction. This weight value also corresponds, for example, to the direction of the communication data transmitted to each area. For example, the communication weight calculation unit 112 may read out, from an internal memory, a matrix having a value closest to the communication beam direction (e.g., a pre-coding matrix or the like). The communication weight calculation unit 112 outputs the calculated weight value to the weight controller 106.

The communication data generation unit 113 generates communication data. Examples of such data include user data such as character data and voice data. The communication data generation unit 113 outputs the generated communication data to the weight controller 106.

The weight controller 106 applies a weight on (e.g., perform a weight application) the communication data according to the weight value received from the communication weight calculation unit 112, and transmits the weighted (or phase-controlled) communication data to the transmitting unit 107. The transmitting unit 107 converts the communication data into a wireless signal, and the antennas 108-1 to 108-n transmit the wireless signal to the terminal 200.

### Configuration Example of Terminal Device

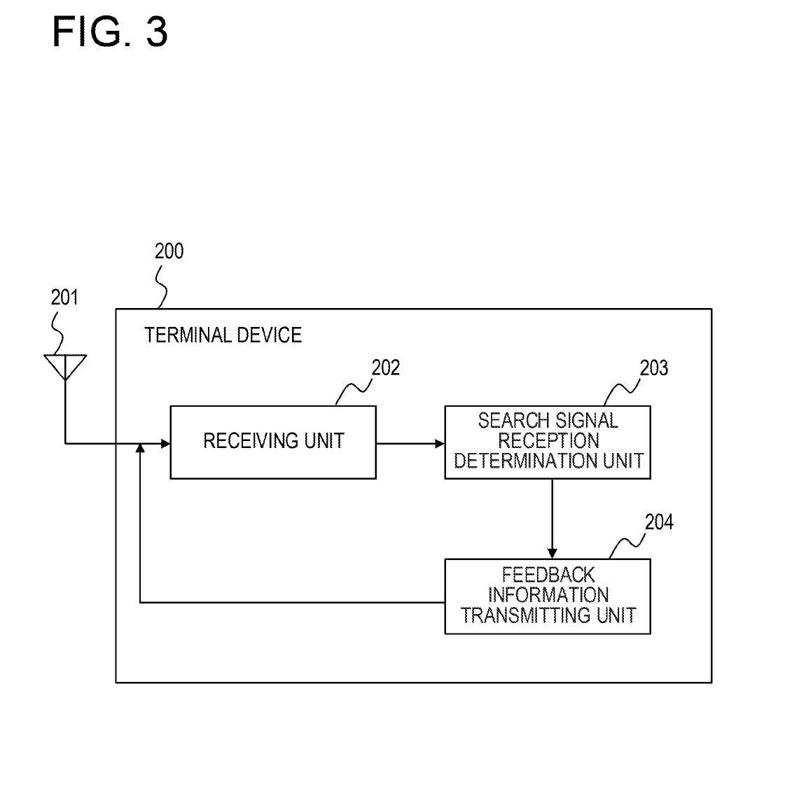

FIG. 3 is a view illustrating a configuration example of the terminal 200. The terminal 200 includes an antenna 201, a receiving unit 202, a search signal reception determination unit 203, and a feedback information transmitting unit 204.

The antenna 201 receives a wireless signal transmitted from the base station 100 and outputs the received wireless signal to the receiving unit 202. Further, the antenna 201 transmits a wireless signal output from the feedback information transmitting unit 204 to the base station 100.

The receiving unit 202 converts the wireless signal into a baseband signal in a baseband and performs a demodulating process or the like on the obtained baseband signal to extract a search signal from the wireless signal. The receiving unit 202 outputs the extracted search signal to the search signal reception determination unit 203.

The search signal reception determination unit 203 performs a beam search based on the received search signal to determine whether the search signal has been normally received. For example, as a result of performing CRC (Cyclic Redundancy Check) using a CRC code added to the search signal, the search signal reception determination unit 203 determines the case as “1” when the search signal has been normally received (or OK), and determines the case as “0” when the search signal has not been normally received (or NG). The search signal reception determination unit 203 outputs the result of the determination to the feedback information transmitting unit 204.

The feedback information transmitting unit 204 performs, for example, a modulating process on the feedback information corresponding to the determination, further converts the modulated feedback information into a wireless signal in a wireless band, and transmits the obtained wireless signal to the antenna 201.

### Hardware Configuration Example

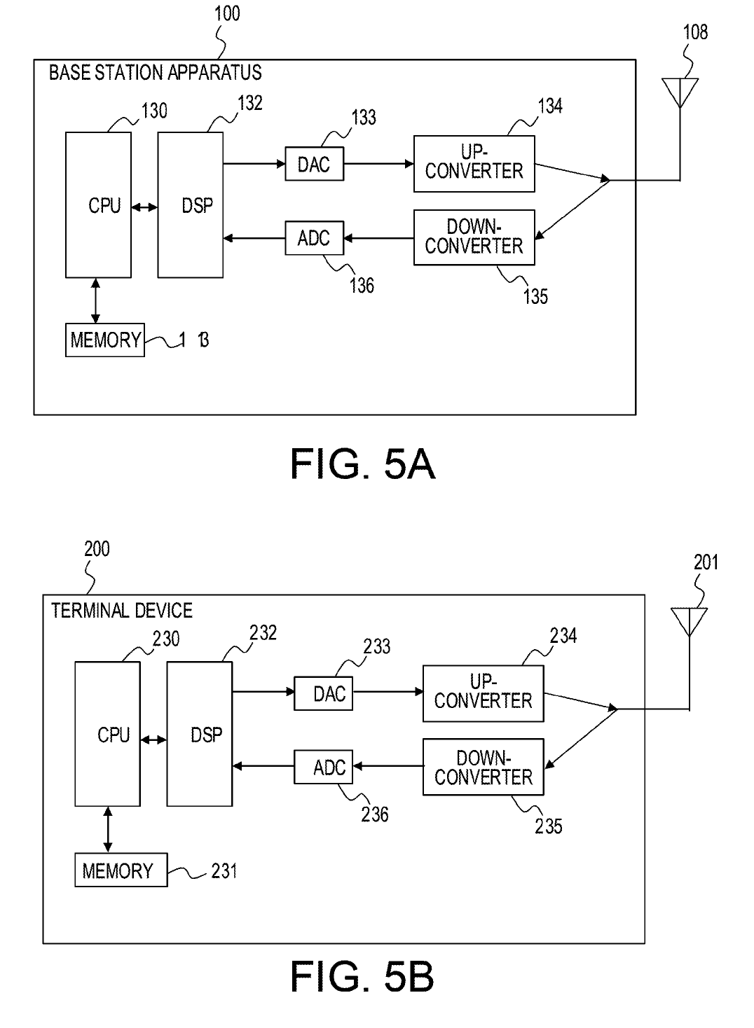

FIG. 5A is a view illustrating an example of a hardware configuration of the base station 100.

The base station 100 includes a CPU (Central Processing Unit) 130, a memory 131, a DSP (Digital Processing Unit) 132, a DAC (Digital to Analogue Converter) 133, and an up-converter 134. The base station 100 further includes a down-converter 135 and an ADC (Analogue to Digital Converter) 136.

By reading out and executing a program stored in the memory 131, the CPU 130 implements the functions of the search signal number determination unit 101, the beam combination determination unit 102, the search beam direction determination unit 103, and the search weight calculation unit 104. In addition, by executing the program, the CPU 140 implements the functions of the search data generation unit 105, the weight controller 106, the feedback information receiving unit 110, the communication beam direction determination unit 111, and the communication data generation unit 113. The CPU 130 corresponds to, for example, the search signal number determination unit 101, the beam combination determination unit 102, the search beam direction determination unit 103, and the search weight calculation unit 104. Further, the CPU 130 corresponds to, for example, the search data generation unit 105, the weight controller 106, the feedback information receiving unit 110, the communication beam direction determination unit 111, and the communication data generation unit 113.

The DSP 132 performs, for example, an error correction coding process, or a modulating process on the search data and communication data received from the CPU 130 to obtain a modulated signal which is then output to the DAC 133. Further, the DSP 132 performs, for example, a demodulating process, or an error correction decoding process on a baseband signal received from the ADC 136 to extract, for example, feedback information, and outputs the extracted feedback information to the CPU 130.

The DAC 133 converts a digital modulated signal received from the DSP 132 into an analog modulated signal and outputs the obtained analog modulated signal to the up-converter 134. The up-converter 134 converts the received analog modulated signal into a wireless signal in a wireless band, which is then output to the antenna 108.

The down-converter 135 converts a wireless signal received from the antenna 108 into a baseband signal in a baseband, which is then output to the ADC 136. The ADC 136 converts the received analog baseband signal into a digital baseband signal which is output to the DSP 132.

The DSP 132, the DAC 133, and the up-converter 134 correspond to, for example, the transmitting unit 107. Further, the down-converter 135, the ADC 136, and the DSP 132 correspond to, for example, the receiving unit 109.

FIG. 5B is a view illustrating an example of a hardware configuration example of the terminal 200.

The terminal 200 includes a CPU 230, a memory 231, a DSP 232, a DAC 233, an up-converter 234, a down-converter 235, and an ADC 236.

By reading out and executing a program stored in the memory 231, the CPU 230 implements the functions of the search signal reception determination unit 203 and the feedback information transmitting unit 204. The CPU 230 corresponds to, for example, the search signal reception determination unit 203 and the feedback information transmitting unit 204.

For example, the DSP 232 performs an error correction coding process, or a modulating process on, for example, the feedback information transmitted from the CPU 230 to obtain a modulated signal which is then output to the DAC 233. In addition, the DSP 232 performs, for example, a demodulating process or an error correction decoding process on a baseband signal received from the ADC 236 to extract, for example, communication data and search data, and outputs the extracted data to the CPU 230.

The DAC 233 converts the digital modulated signal received from the DSP 232 into an analog modulated signal and outputs the obtained analog modulated signal to the up-converter 234. The up-converter 234 converts the received analog modulated signal into a wireless signal in a wireless band, which is then output to the antenna 201.

The down-converter 235 converts a wireless signal received from the antenna 201 into a baseband signal in a baseband, which is then output to the ADC 236. The ADC 236 converts the analog baseband signal into a digital baseband signal which is then output to the DSP 232.

The DSP 232, the DAC 233, and the up-converter 234 correspond to, for example, the feedback information transmitting unit 204. Further, the down-converter 235, the ADC 236, and the DSP 232 correspond to, for example, the receiving unit 202.

The CPUs 130 and 230 may be replaced with a processor or a controller such as an MPU (Micro Processing Unit), a DSP, or a FPGA (Field Programmable Gate Array).

### Operation Example

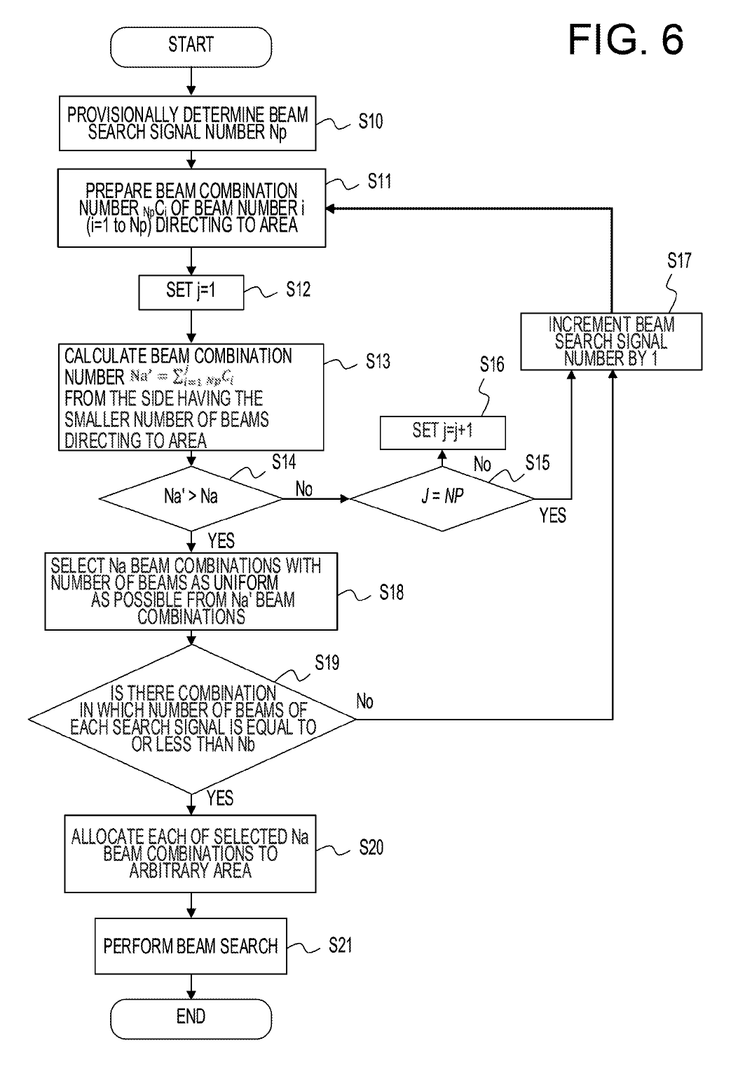

FIG. 6 is a flowchart illustrating an operation example of the base station 100. In this operation example, the base station 100 determines a combination of each area where a beam search is performed and the presence/absence of search signal transmission.

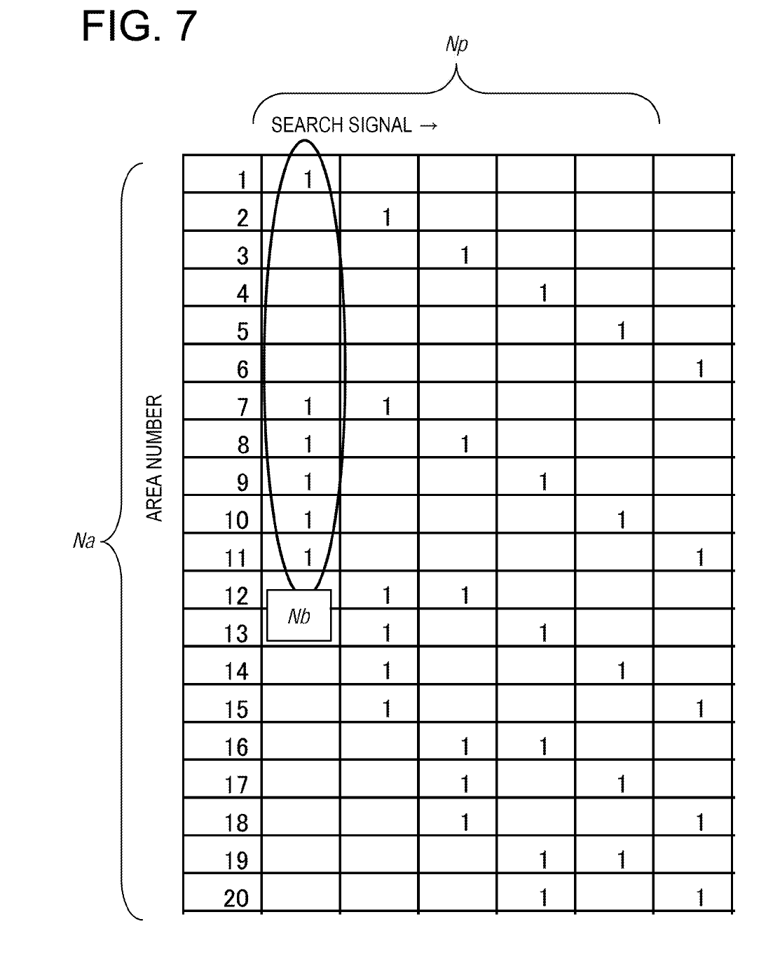

FIG. 7 illustrates such a combination in a tabular form. In FIG. 7, the vertical direction indicates an area number of each area. In the example of FIG. 7, the area number is from “1” to “20”. The number of areas Na is 20. The horizontal direction indicates the number of times of search signal transmission. In the example of FIG. 7, the number of search signals ranges from “1” to “6”. The minimum value Np of the number of transmissions is 6. Also, in the following example, it is assumed that one beam is formed by one search signal.

In the base station 100, based on the area number Na and the number Nb of beams formed by one time transmission of a beam search signal, the minimum value Np of the number of transmissions of the search signal for performing the beam search in all the areas is determined. In the example of FIG. 7, with the constraint of Nb=6 at each time of transmitting the search signal, transmission with Np=6 as the minimum value of the number of transmissions is performed in an order to perform the beam search in all the areas.

As the beam number Nb becomes smaller, the number of search signals transmitted in one time transmission becomes smaller. In the meantime, the transmission power used for one time search signal transmission is constant. Therefore, as the number of search signals transmitted in one time transmission decreases, the transmission power given to one search signal increases. As the transmission power given to one search signal increases, it becomes possible to make one search signal reach farther. The magnitude of the transmission power given to one search signal may sometimes be referred to as a beam gain. The beam gain increases as the beam number Nb decreases.

In the first embodiment, the base station 100 increases the beam gain so that the search signal reaches the terminal 200 located in the service-area end, and determines a combination of beams so that the beam search is performed in all the areas.

As illustrated in FIG. 6, when starting a process, the base station 100 provisionally determines the number of transmissions Np of the beam search signal (hereinafter, sometimes referred to as “the number of search signals”) (S10). For example, the search signal number determination unit 101 provisionally determines the search signal number Np=6.

Next, the base station 100 prepares the number of beam combinations ₙₚCᵢ of the number of beams i (i=1 to Np) directing to an area (S11).

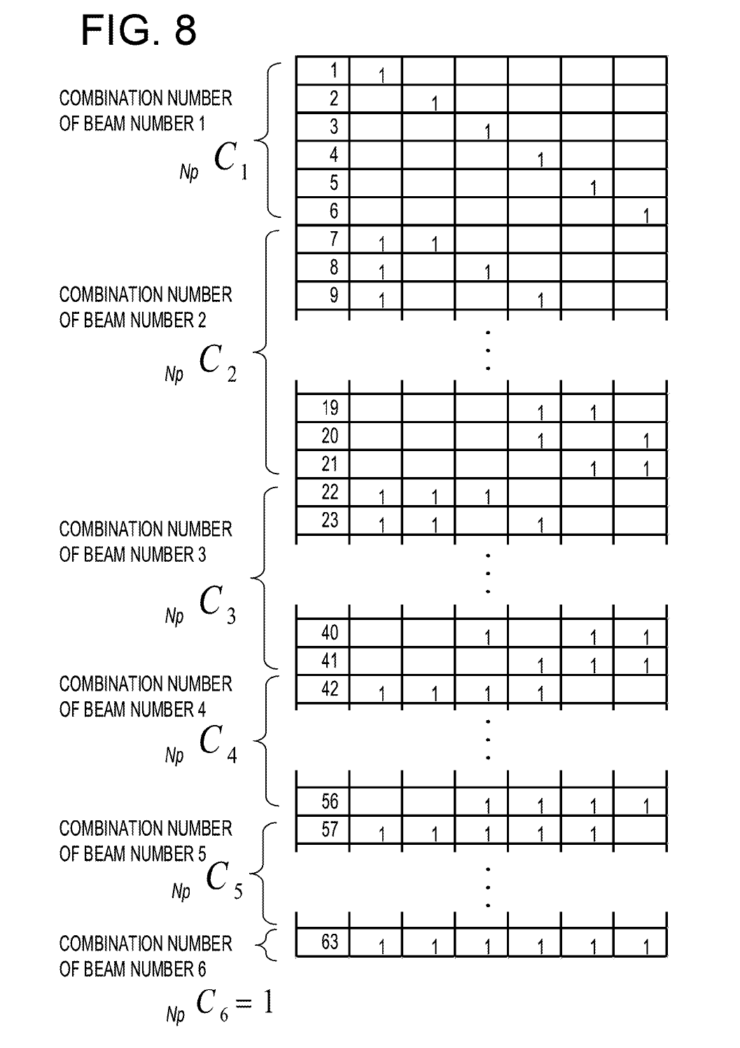

FIG. 8 is a view illustrating an example of the number of beam combinations ₙₚCᵢ. In the case of the search signal number Np=6, the number of combinations in which the beam number is “1” in each of 6 search signal numbers is ₆C₁=6. In the example of FIG. 8, the beam number “1” is allocated to each area of area numbers “1” to “6”.

Similarly, the number of combinations in which the beam number is “2” in each of 6 search signal numbers is ₆C₂=15. In the example of FIG. 8, the beam number “2” is allocated to each area of area numbers “7” to “21”.

Similarly, in the case of six search signal numbers, the number of combinations with the beam number of “3” is ₆C₃=20 and the number of combinations with the beam number of “4” is ₆C₄=15. Furthermore, the number of combinations of the beam numbers of “5” and “6” are ₆C₅=6 and ₆C₆=1, respectively. For example, the beam search signal number determination unit 101 calculates values from ₆C₁ to ₆C₆.

Referring back to FIG. 6, next, the base station 100 substitutes “1” for j (S12). The symbol “j” represents, for example, the number of beams directing to an area. For example, the search signal number determination unit 101 changes “j” from “1” to “Np” in an order and performs the following calculation.

Next, the base station 100 calculates a beam combination number Na′ from the side having the smaller number of beams directing to the area (S13). For example, the search signal number determination unit 101 may read out the following equation from an internal memory and substitute the beam combination number ₙₚCᵢ prepared in S11 into the equation.

$${Na}^{′} = {( {\sum }_{i = 1}^{j} )}_{Np} {C}_{i} \qquad ( 1 )$$

For example, in the above example, Na′=₆C₁=6 when j=1, and Na′=₆C₁+₆C₂=21 when j=2.

Next, the base station 100 determines whether Na′>Na (S14). Here, for example, the search signal number determination unit 101 determines whether the beam combination number Na′ is larger than the area number Na. When j=1, since Na′=6 and but Na′>Na=63 does not hold, the search signal number determination unit 101 determines that the beam combination number Na′ is not larger than the area number Na.

When it is determined that Na′>Na does not hold (“No” in S14), the base station 100 determines whether j=Np (S15). For example, the search signal number determination unit 101 repeats the process of adding Na′ (S13) until j reaches “Np” while incrementing j by 1, but in this process, determines whether j reaches a provisionally determined search signal number “Np”. Specifically, when the combination number Na′ is equal to or less than the area number Na, the search signal number determination unit 101 performs a process after S15.

When it is determined that j≠Np (“No” in S15), the base station 100 adds 1 to j and calculates Na′ (S16 and S13). For example, the search signal number determination unit 101 sets j to j+1 and calculates Na′ using j after the addition. In the above example, the search signal number determination unit 101 calculates Na′ with j=2 to obtain Na′=₆C₁+₆C₂=21. Thereafter, when Na′>Na=63 does not hold, the search signal number determination unit 101 adds 1 to j and repeats the calculation of Na′ until j reaches the temporarily determined Np.

In the meantime, when it is determined that j=Np (“Yes” in S15), the base station 100 increments the provisionally determined search signal number Np by “1” (S17). For example, the search signal number determination unit 101 calculates Na′ until j=Np by adding 1 to j, but does not create a search signal combination number larger than the area number Na (or Na′>Na does not hold). Therefore, the search signal number determination unit 101 adds “1” to the provisionally determined search signal number Np and again calculates a search signal combination number larger than the area number Na (S11 to S16). In the above example, when the area number Na=64, Na′>Na is not satisfied (“No” in S14) even when j=Np=6 because Na′=6+15+20+15+6+1=63<64=Na. In this case, the search signal number determination unit 101 increments the search signal number to provisionally determine “7”, and repeats the process from S11 to S17 until the beam combination number Na′ becomes larger than the area number Na.

In the meantime, when it is determined that Na′>Na (“Yes” in S14), the base station 100 selects Na beam combinations with the number of beams as uniform as possible from the Na′ beam combinations (S18).

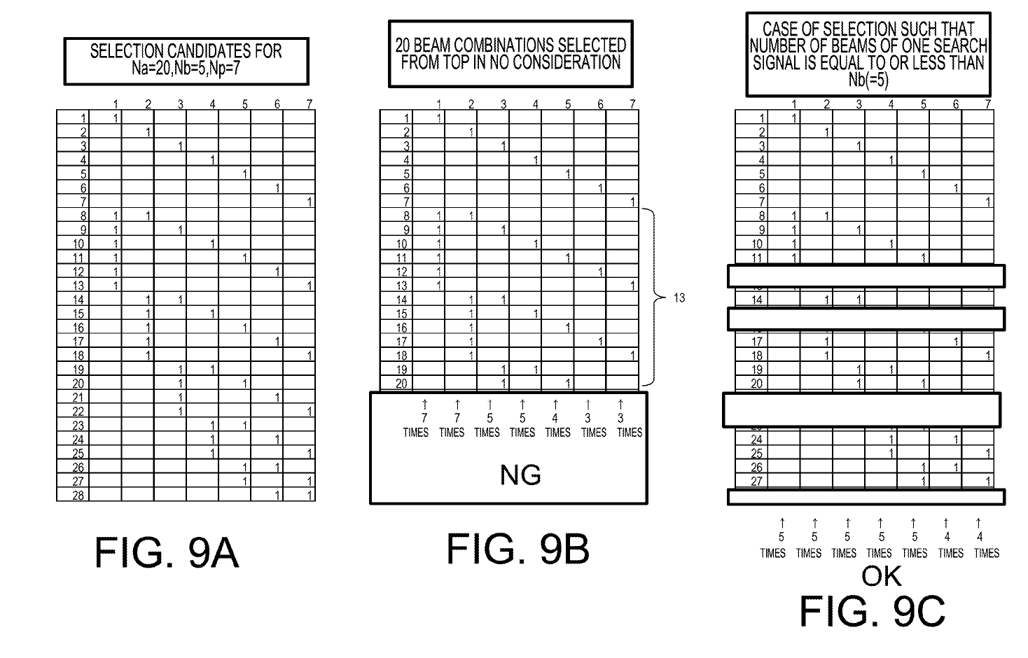

FIG. 9A illustrates a table of beam combinations obtained with the search signal number minimum value Np=7 and Na′=28 (=₇C₁+₇C₂=28) for the area number Na=20, as a result of the process from S11 to S17. In FIG. 9A, the vertical direction represents the area number and the horizontal direction represents the search signal number. In the table, “1” indicates an area where a search signal is transmitted.

For example, the search signal number determination unit 101 selects Na=20 beams from Na′=28 beam combinations in S15 so that the number of beams becomes uniform. Here, the term “uniform” indicates, for example, that the number of beams becomes equal for each of the number of transmissions of search signal of “1” (or Np=1), “2” (or Np=2), . . . .

FIG. 9B is a view illustrating an example in a case where Na=20 beam combinations are selected in an order from the area number “1” among the Na′=27 beam combinations. In this case, the number of beams each time from the number of beam transmissions of “1” to “7” is “7”, “7”, “5”, “5”, “4”, “3”, and “3” and the number of beams at each time is not “uniform”.

In the meantime, FIG. 9C is a view illustrating an example in a case where Na=20 beam combinations are selected among the Na′=27 beam combinations so that the number of beams becomes uniform. In this case, the number of beams for the number of transmissions of “1” to “5” is “5” and the number of beams for the number of transmissions of “6” and “7” is “4”, which are clearly “uniform” as compared with FIG. 9B. A specific selection method will be described later. Here, for example, the search signal number determination unit 101 selects Na beam combinations from Na′ beam combinations.

Although Na has been described as the area number, the area number and the beam combination number are equal in the following because there are beam combinations corresponding to the area number. In the following, the area number Na and the beam combination number Na may be used without distinction.

Referring back to FIG. 6, next, the base station 100 determines whether there is a combination in which the number of beams of each search signal is equal to or less than Nb (S19). For example, the search signal number determination unit 101 determines whether the number of beams is equal to or less than Nb for each transmission of the search signal for the selected Na beam combinations.

For example, in the example of FIG. 9C, the search signal number determination unit 101 determines whether Nb is equal to or less than 5 for each of the number of transmissions of “1” to “7”.

Referring back to FIG. 6, when it is determined that there is no combination in which the number of beams is equal to or less than Nb for the selected Na beam combinations (“No” in S19), the base station 100 increments the search signal number by “1” to set Np+1 and performs a process after S11 (S17).

In this case, for example, in the search signal number determination unit 101, Na beam combinations are selected among Na′ beam combinations, but a combination in which the number of beams per transmission of search signal is larger than Nb is included in the selected combinations. In this case, the search signal number determination unit 101 increments the number of beam transmissions by “1” and again selects a beam combination (S11 to S18).

In the meantime, when it is determined that there is a combination in which the number of beams is equal to or less than Nb (“Yes” in S19), the base station 100 allocates the selected Na beam combinations to an arbitrary area (S20).

For example, in the example of FIG. 9C, since the number of beams is equal to or less than Nb in each of the number of transmissions of “1” to “7”, the search signal number determination unit 101 determines that there is a combination in which the number of beams is equal to or less than Nb. In this case, the search signal number determination unit 101 outputs information indicating a combination of transmission/non-transmission of search signals to each area to the beam combination determination unit 102. The beam combination determination unit 102 allocates the presence/absence of search signal transmission to an area of the base station 100 corresponding to each area number.

Eventually, the base station 100 selects a combination of Na area numbers from Na′ beam combinations (S18). When it is determined that the number of beams is all equal to or less than Nb for each number of transmissions for the selected combination (“Yes” in S19), Np is determined as the minimum value. When it is determined that the number of beams is larger than Nb by even one beam for the selected combination (“No” in S19), Np is incremented by one (S17) and the provisional determination is maintained. Therefore, in the case of “Yes” in S19, the provisionally determined Np becomes the minimum value Np of the number of transmissions. For example, in the case of “Yes” in S19, the search signal number determination unit 101 may determine the provisionally determined Np as the minimum value Np of the number of transmissions.

Referring back to FIG. 6, next, the base station 100 forms a beam by the search signal transmission, and the terminal 200 performs a beam search using the search signal (S21). For example, the base station performs the following process.

Specifically, the beam combination determination unit 102 outputs allocation information indicating the presence/absence of transmission of the search signal for each area to the search beam direction determination unit 103. The search beam direction determination unit 103 outputs a beam transmission angle relative to the reference angle to the search weight calculation unit 104 based on the allocation information. The search weight calculation unit 104 calculates a weight value corresponding to the transmission angle and outputs the calculated weight value to the weight controller 106. The weight controller 106 applies a weight on the search data based on the weight value and outputs the weighted search data to the transmitting unit 107, and the transmitting unit 107 transmits the data to the terminal 200 as a search signal. The terminal 200 performs a beam search based on the search signal.

### Selection Method of Selecting Beam Combination Number Na so that the Number of Beams is Uniform

Next, a selection method of selecting a beam combination number Na (S18) so that the number of beams is uniform will be described.

As a specific example, descriptions will be given by taking an example of selecting the beam combination number Na=20 illustrated in FIG. 9C from the beam combination number Na′=27 illustrated in FIG. 9A. However, the selection method described below is merely an example and may be other known selection methods.

First, the search signal number determination unit 101 adds an area number for each number of transmissions so that the area number Na becomes 20.

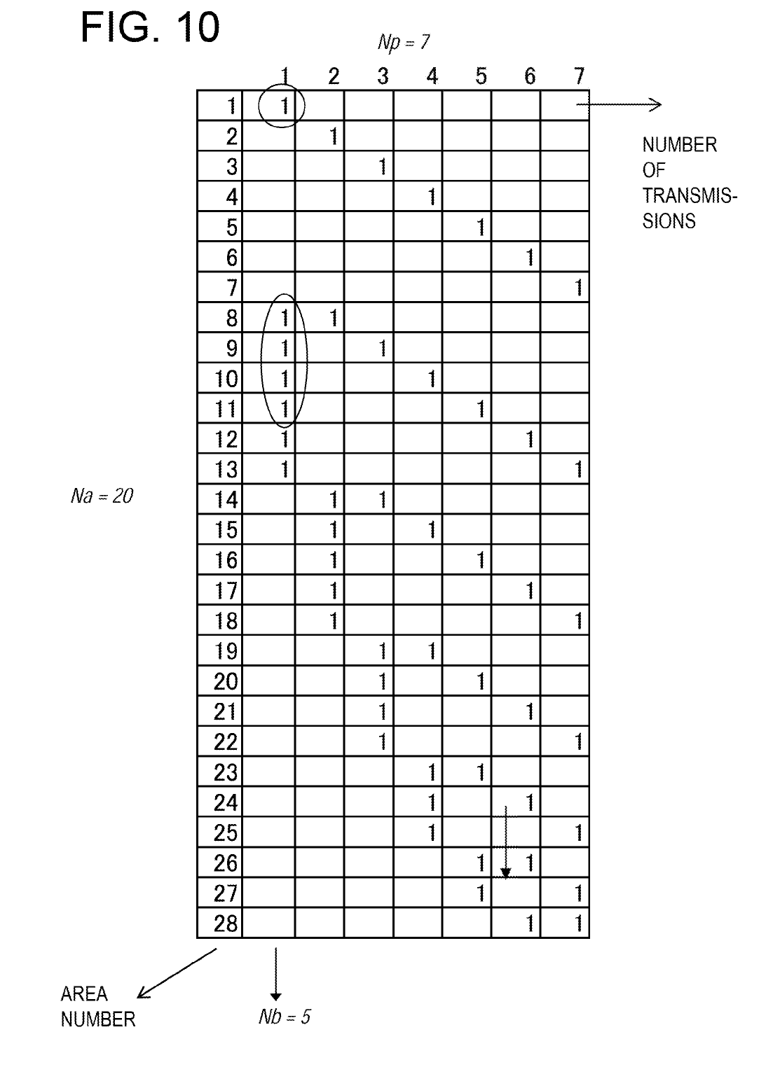

FIG. 10 is a view illustrating a beam combination example satisfying Na′>Na which is the same as FIG. 9A. In the example of FIG. 10, the area number of the number of transmissions of “1” is “7” and the area number of the number of transmissions of “2” is “21”. With an addition in an order from the side with the smaller number of transmissions, the entire areas “7” of the number of transmissions of “1” and the areas “13” of the number of transmissions of “2” are added to obtain Na=20.

Next, the search signal number determination unit 101 calculates an estimate of the number of beams per the number of transmissions of “1”. In the example of FIG. 10, the estimate is 1×7+2×13=33/(7(=Np))=4.714 and so on. Therefore, in this example, the search signal number determination unit 101 sets “5” as the estimate of the number of beams per the number of transmissions of “1”.

Next, the search signal number determination unit 101 determines a combination of the number of assignments so that the total number is equal to or less than the estimated number of beams. In the example of FIG. 10, there are two combinations of “5×5+4×2” and “5×6+3×1”, which are less than “5” and equal to “33” in total. For example, the search signal number determination unit 101 selects “5×5+4×2”. In this case, the search signal number determination unit 101 may select “5×6+3×1”.

Next, the search signal number determination unit 101 allocates the number of beams at each number of transmissions. In the example of FIG. 10, the search signal number determination unit 101 determines that the number of beams is “5” from the number of transmissions of “1” to “5” and the number of beams is “4” at the number of transmissions of “6” and “7”.

Next, the search signal number determination unit 101 determines a beam to be transmitted at each number of transmissions.

In the example of FIG. 10, the search signal number determination unit 101 selects, for example, five beams as a beam combination of the number of transmissions of “1” as follows.

Specifically, the search signal number determination unit 101 unconditionally selects the area number “1” where the number of beams is “1”. Next, the search signal number determination unit 101 may select four area numbers from the area numbers “8” to “13” with the number of beams of “2”. Here, the search signal number determination unit 101 selects four area numbers “8” to “11” in the descending order of area number. That is, the search signal number determination unit 101 does not select two combinations of the area numbers “12” and “13”.

At the number of transmissions of “1”, the search signal number determination unit 101 selects combinations of the area numbers “1” and “8” to “11”. Since the selection number is “5”, “5” (Nb=5) which is the number of beams selected for the first time is satisfied.

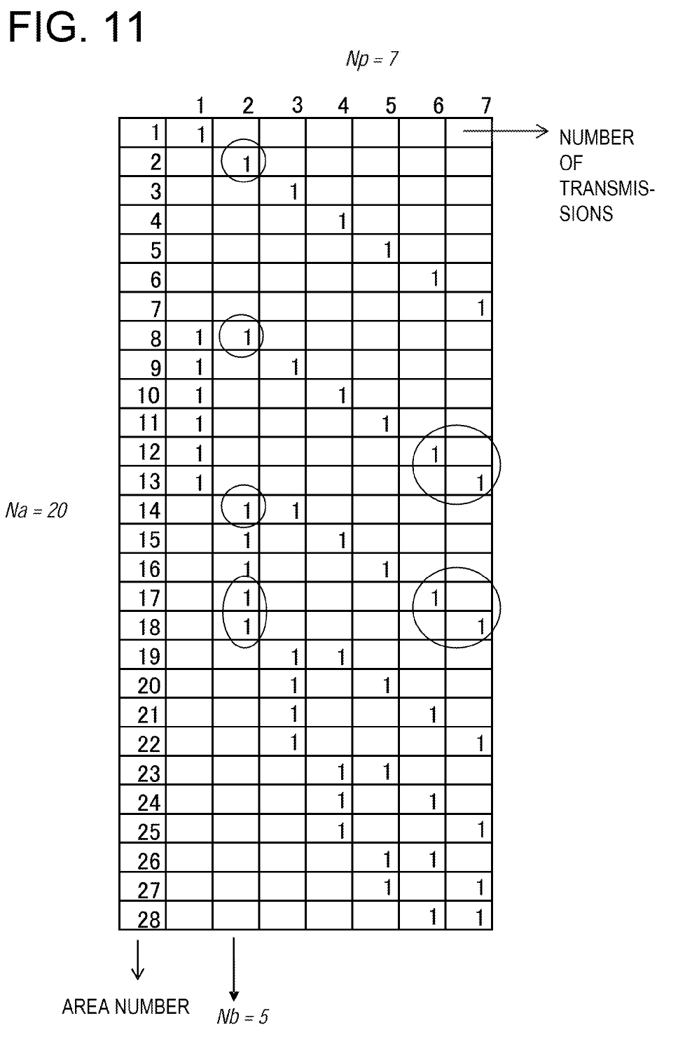

FIG. 11 is a view illustrating an example of selection of a beam combination of the number of transmissions of “2”. The search signal number determination unit 101 selects, for example, five beams for the number of transmissions of “2” as follows.

Specifically, the search signal number determination unit 101 unconditionally selects the area number “2” where the number of beams is “1”. In addition, the search signal number determination unit 101 also unconditionally selects the area number “8” selected in the first transmission. Next, the search signal number determination unit 101 selects three combinations in the area numbers “14” to “18”. In this case, paying attention to the beam combinations of the area numbers “12” and “13” which are not selected in the first transmission, there is a combination of beam transmission performed at the number of transmissions of “6” and the number of transmissions of “7”. In the area numbers “14” to “18”, the combination of beam transmission at the number of transmissions of “6” and the number of transmissions of “7” is the combination of the area numbers “17” and “18”. Therefore, the search signal number determination unit 101 selects a combination of the area numbers “17” and “18” among the area numbers “14” to “18”.

Here, for example, by selecting a combination to be transmitted with other number of transmissions among combinations not selected in the previous number of time of transmission, by the number of transmissions this time, the number of beams may be selected to be uniform at each number of transmissions.

As a selection of the remaining one beam combination, the search signal number determination unit 101 selects a combination of the smallest area number “14” among the area numbers “14” to “16”.

In summary, the search signal number determination unit 101 selects the area numbers “2”, “8”, “14”, “17”, and “18” as beam combinations of the number of transmissions of “2”. Since the selection number is “5”, “5” (Nb=5) which is the number of beams selected for the second time is satisfied.

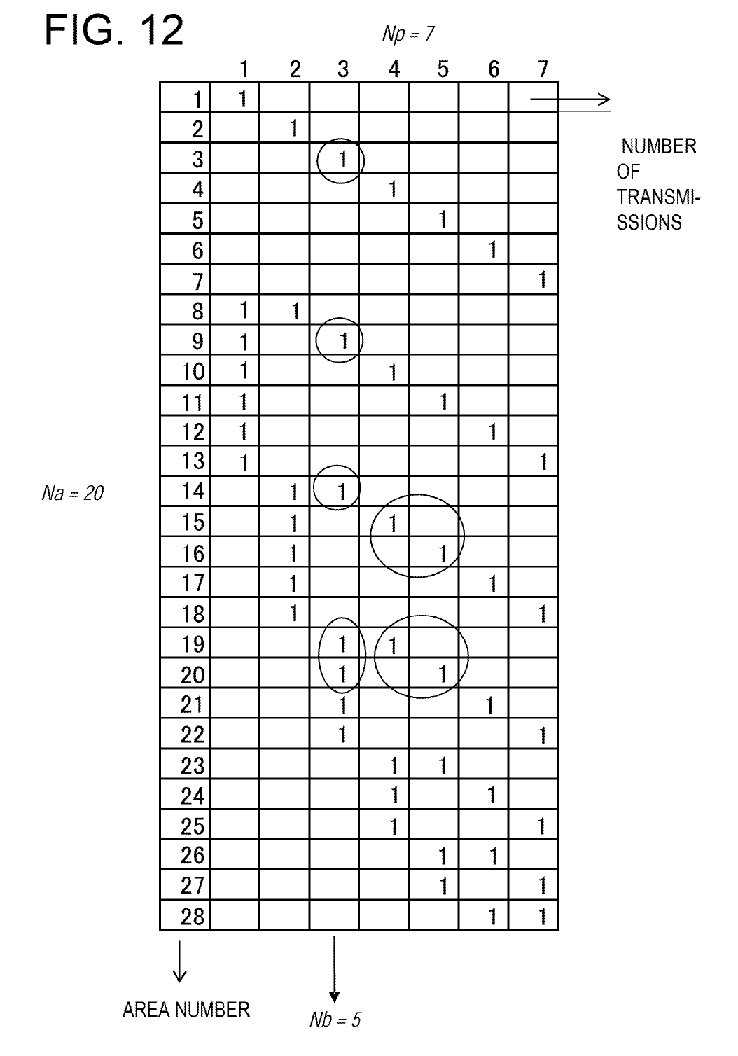

FIG. 12 is a view illustrating an example of selection of a beam combination of the number of transmissions of “3”. The search signal number determination unit 101 selects, for example, five beams as the number of transmissions of “3” as follows.

Specifically, the search signal number determination unit 101 unconditionally selects the area number “3” where the number of beams is “1”. In addition, the search signal number determination unit 101 also unconditionally selects the area number “9” selected in the first transmission. Further, the search signal number determination unit 101 also unconditionally selects the area number “14” selected in the second transmission. Next, the search signal number determination unit 101 selects two combinations in the area numbers “19” to “22”. In this case, paying attention to the beam combinations of the area numbers “15” and “16” which are not selected in the second transmission, there is a combination of beam transmission performed at the number of transmissions of “4” and the number of transmissions of “5”. In the area numbers “19” to “22”, the combination of beam transmission at the number of transmissions of “4” and the number of transmissions of “5” is the combination of the area numbers “19” and “20”. Therefore, the search signal number determination unit 101 selects a combination of the area numbers “19” and “20” among the area numbers “19” to “22”.

In summary, the search signal number determination unit 101 selects the area numbers “3”, “9”, “14”, “19”, and “20” as beam combinations of the number of transmissions of “3”. Since the selection number is “5”, “5” (Nb=5) which is the number of beams selected for the third time is satisfied.

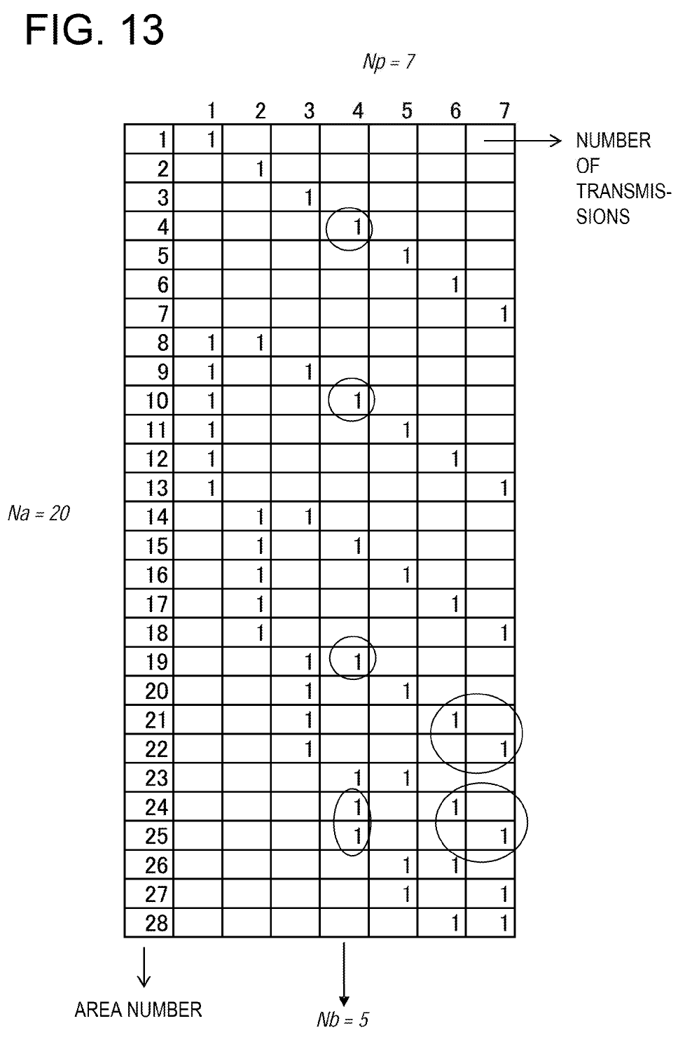

FIG. 13 is a view illustrating an example of selection of a beam combination of the number of transmissions of “4”. The search signal number determination unit 101 selects, for example, five beams as the number of transmissions of “4” as follows.

Specifically, the search signal number determination unit 101 unconditionally selects the area number “4” where the number of beams is “1”. In addition, the search signal number determination unit 101 also unconditionally selects the area number “10” selected in the first transmission. Further, the search signal number determination unit 101 also unconditionally selects the area number “19” selected in the third transmission. Next, the search signal number determination unit 101 selects two combinations in the area numbers “23” to “25”. In this case, paying attention to the beam combinations of the area numbers “21” and “22” which are not selected in the third transmission, there is a combination of beam transmission performed at the number of transmissions of “6” and the number of transmissions of “7”. In the area numbers “23” to “25”, the combination of beam transmission at the number of transmissions of “6” and the number of transmissions of “7” is the combination of the area numbers “24” and “25”. Therefore, the search signal number determination unit 101 selects a combination of the area numbers “24” and “25” among the area numbers “23” to “25”.

In summary, the search signal number determination unit 101 selects the area numbers “4”, “10”, “19”, “24”, and “25” as beam combinations of the number of transmissions of “4”. Since the selection number is “5”, “5” (Nb=5) which is the number of beams selected for the fourth time is satisfied.

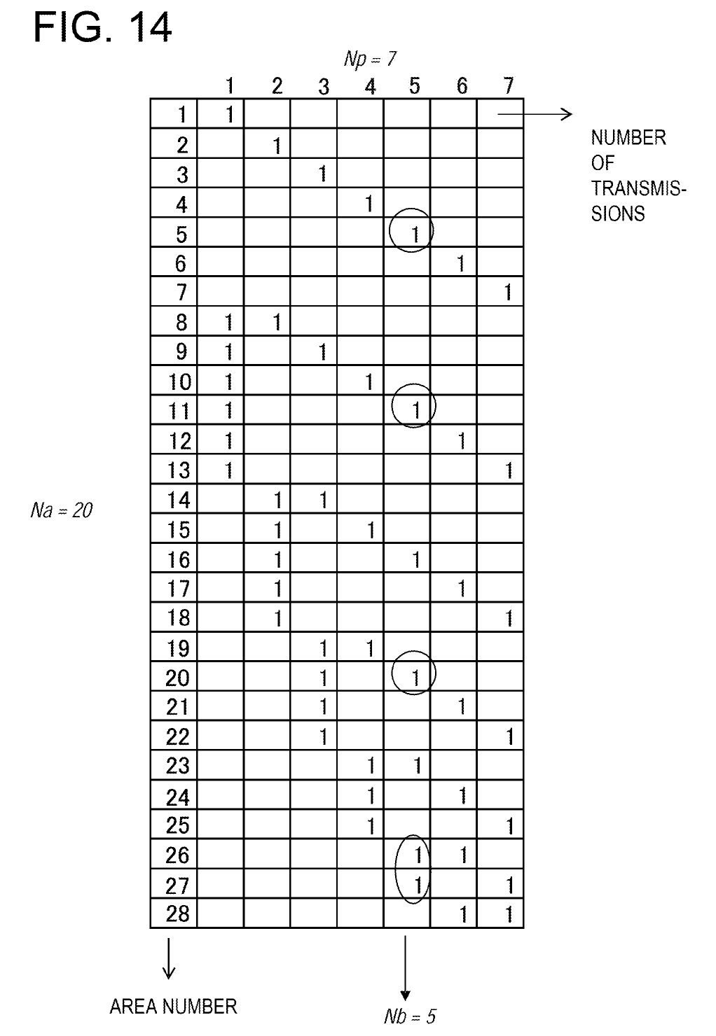

FIG. 14 is a view illustrating an example of selection of a beam combination of the number of transmissions of “5”. The search signal number determination unit 101 selects, for example, five beams as the number of transmissions of “5” as follows.

Specifically, the search signal number determination unit 101 unconditionally selects the area number “5” where the number of beams is “1”, the area number “11” selected in the first transmission, and the area number “20” selected in the third transmission. The search signal number determination unit 101 automatically selects the remaining area numbers “26” and “27”.

The search signal number determination unit 101 selects a combination of the area numbers “5”, “11”, “20”, “26”, and “27” in the number of transmissions of “5”. Since the selection number is “5”, the number “5” (Nb=5) which is the number of beams selected for the fifth time is satisfied.

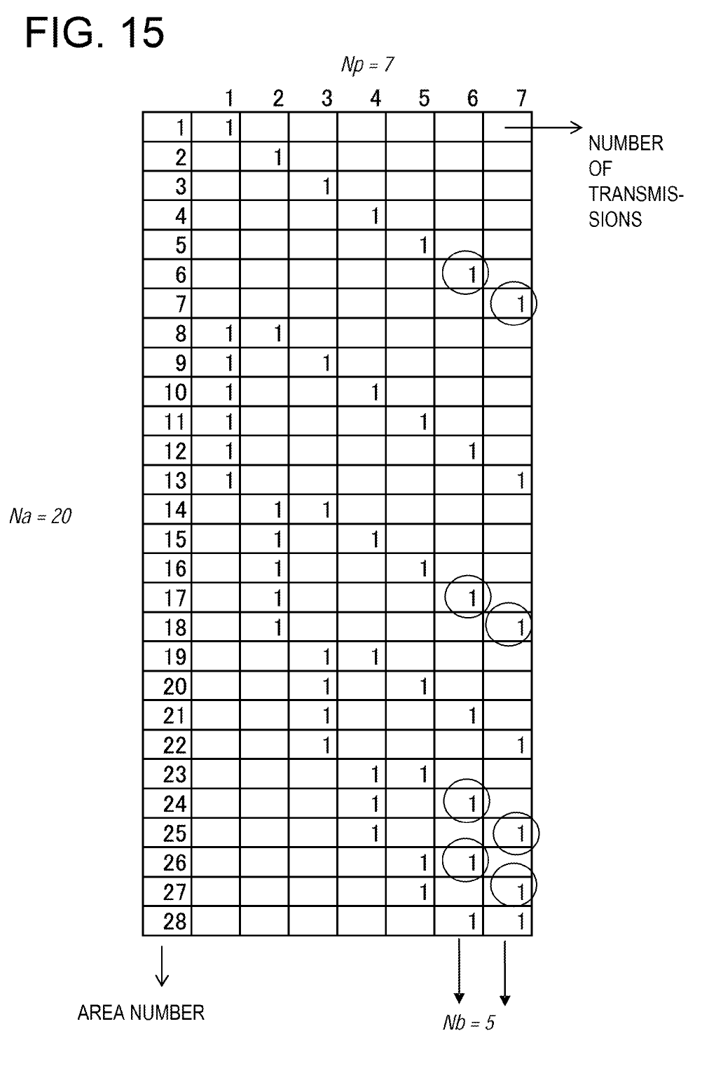

FIG. 15 is a view illustrating an example of selection of a beam combination of the number of transmissions of “6”. The search signal number determination unit 101 selects, for example, four beams as the number of transmissions of “6” as follows.

Specifically, the search signal number determination unit 101 unconditionally selects the area number “6” where the number of beams is “1”, the area number “17” selected in the second transmission, the area number “24” selected in the fourth transmission, and the area number “26” selected in the fifth transmission. Thus, “4” (<Nb=5) which is the number of beams selected for the sixth time is all selected.

In addition, FIG. 15 is a view illustrating an example of selection of a beam combination of the number of transmissions of “7”. The search signal number determination unit 101 selects, for example, four beams as the number of transmissions of “7” as follows.

Specifically, the search signal number determination unit 101 unconditionally selects the area number “7” where the number of beams is “1”, the area number “18” selected in the second transmission, the area number “25” selected in the fourth transmission, and the area number “27” selected in the fifth transmission. Thus, the number “4” (<Nb=5) which is the number of beams selected for the seventh time is all selected.

Thus, for example, a beam combination number Na is selected so that the number of beams becomes uniform. As a result, it becomes possible to obtain the beam combination illustrated in FIG. 9C.

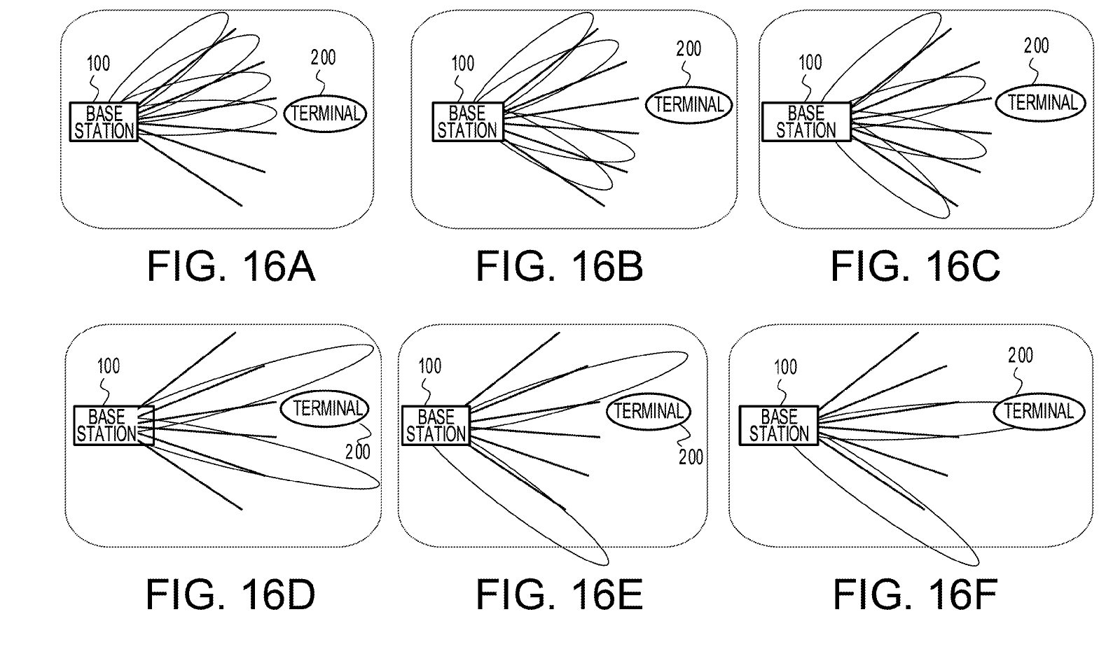

FIGS. 16A to 16C are views illustrating an example of forming a beam when the number of beams is “4” at each number of transmissions. In the meantime, FIGS. 16D to 16F are views illustrating an example of forming a beam when the number of beams is “2” at each number of transmissions. As illustrated in these figures, the smaller number of beams transmitted in one time transmission allows the base station 100 to transmit the beams farther.

Accordingly, as illustrated in FIG. 16F, a search signal may reach the terminal 200 located in an area end, and the terminal 200 may feedback a correct determination result to the base station 100 by conducting a beam search using this search signal. Then, the base station 100 may correctly detect an area in which the terminal 200 is located, and may transmit data to that area.

When the search signal does not reach the terminal 200, the base station 100 may not detect the direction of the terminal 200, and may repeat transmission of data many times. In this case, a throughput to the terminal 200 may decrease.

However, in the first embodiment, the base station 100 may transmit data to the terminal 200 by one time data transmission toward the direction of the terminal 200 acquired in a search period. As a result, it becomes possible to improve a throughput of the wireless communication system 10.

### Other Embodiments

In the first embodiment, an example of calculating the minimum value Np of the number of transmissions times has been described. In this case, even when the search signal is transmitted to each area by the number of transmissions of the minimum value Np, there is a case in which it is not possible for the terminal 200 to normally determine the reception due to the propagation environments in which the search signal is propagated. Therefore, the base station 100 may have redundancy in the number of transmissions.

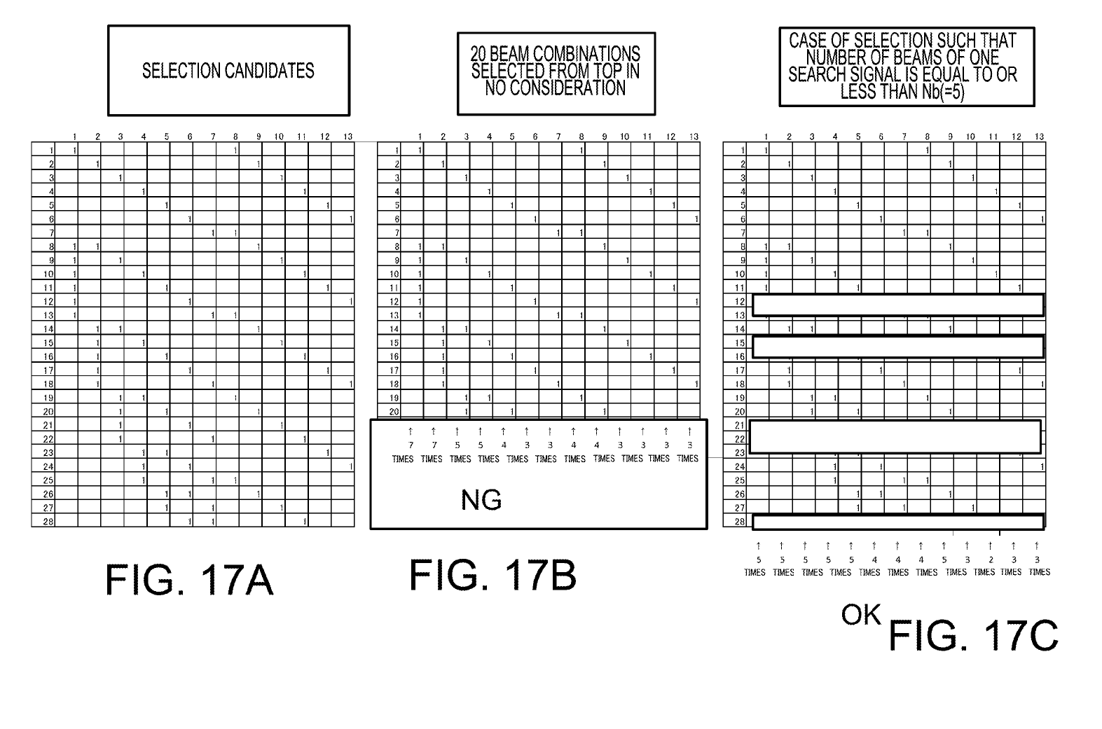

FIGS. 17A to 17C are views illustrating examples of a beam combination in such a case. As illustrated in FIGS. 17A to 17C, the number of times of search signal transmission is “13” which is obtained by adding “6” to the minimum value Np=7.

For example, the search signal number determination unit 101 determines the number of transmissions, which is larger than the minimum value Np of the calculated number of search signal transmissions, in S18 of FIG. 6. Specifically, for example, the search signal number determination unit 101 adds the number of transmissions of a predetermined number (e.g., “6” for Np=7) to the minimum value Np. In this case, the search signal number determination unit 101 may select Na combinations among Na′ beam search combinations based on the added number of transmissions. As a selection method, the above-mentioned “Selection Method of Selecting Beam Combination Number Na So That the Number of Beams Is Uniform> may be used. That is, based on an area number and the number of beams formed by one time transmission of a beam search signal, the search signal number determination unit 101 determines the number of search signal transmissions (“13” in the example of FIG. 17A) for performing a beam search in all areas. Then, the search signal number determination unit 101 determines a combination of an area and the presence/absence of beam for the number of transmissions.

Further, in the above-described first embodiment, an example in which beam forming is performed in the base station 100 and a beam search is performed in the terminal 200 has been described. However, for example, beam forming may be performed in the terminal 200 and a beam search may be performed in the base station 100. In this case, the configuration example of the terminal 200 is as illustrated in FIG. 2, and the configuration example of the base station 100 is as illustrated in FIG. 3. Based on the area number and the number of beams formed by one time transmission of a search signal, the terminal 200 determines (the minimum value of) the number of times of search signal transmission for performing the beam search in all the areas, and may determine a beam combination or each area corresponding to the number of transmissions. Then, according to the combination, the terminal 200 may transmit a search signal to the base station 100, and the base station 100 arranged in each area may conduct a beam search based on the search signal.

Further, it has been illustrated in the above-described first embodiment that one beam is formed by one search signal. However, for example, one beam may be formed by plural search signals. In this case, one beam may be formed by simultaneously transmitting the plural search signals from the base station 100 by one time search signal transmission.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a memory; and
a processor coupled to the memory and configured to:
determine a number of transmissions of beam search signal for performing a beam search in an area where the beam search is performed, and determine a combination of the area and a presence/absence of the beam search signal according to the determined number of transmissions of beam search signal, based on a number of areas where the beam search is performed and a number of beams formed in the area by a transmission time of the beam search signal by the wireless communication apparatus; and
generate the beam search signal to be transmitted to another wireless communication apparatus according to the determined combination.

2. The wireless communication apparatus according to claim 1, wherein the processor is further configured to:
determine a minimum value of the number of transmissions of beam search signal, based on the number of areas and the number of beams; and
determine the combination of the area and the presence/absence of the beam search signal according to the determined minimum value.

3. The wireless communication apparatus according to claim 2, wherein the processor is further configured to:
by increasing the number of beams formed in the area in an order from “1” until a number of combinations of the area and the presence/absence of the beam search signal becomes larger than the number of areas,
calculate the number of combinations;
select combinations of the number of areas from the determined number of combinations; and
determine the number of transmissions when the number of beams in the area in the selected combinations becomes equal to or less the number of beams increased in the order from “1”, as the minimum value of the number of transmissions.

4. The wireless communication apparatus according to claim 3, wherein the processor is further configured to:
increment the number of transmissions when there is a combination in which the number of beams in the area in the selected combination is greater than the number of beams increased in the order from “1”; and
based on the incremented number of transmissions, determine the incremented number of transmissions when the number of beams in the area in the selected combination becomes equal to or less than the number of beams increased in the order from “1”, as the minimum value of the number of transmissions.

5. The wireless communication apparatus according to claim 3, wherein the processor is further configured to:
determine a provisional number of transmissions as the number of transmissions;
calculate the number of combinations until the number of combinations reaches the provisional number of transmissions when the calculated number of combinations becomes equal to or less than the number of areas;
increment the provisional number of transmission time when the calculated number of combinations is equal to or less than the number of areas; and
based on the incremented provisional number of transmissions, calculate the number of combinations in an order from “1” in the number of beams formed in the area until the number of combinations becomes larger than the number of areas.

6. The wireless communication apparatus according to claim 5, wherein the processor is further configured to:
select the combinations of the number of areas from the calculated number of combinations when the number of combinations becomes larger than the number of areas; and
determine the provisional number of transmissions when the number of beams in the area in selected combination becomes equal to or less than the number of beams, as the minimum value of the number of transmissions.

7. The wireless communication apparatus according to claim 2, wherein the processor is further configured to:
determine the combination of the area and the presence/absence of the beam search signal according to the number of transmissions that is greater than the minimum value.

8. The wireless communication apparatus according to claim 1, wherein the processor is further configured to:
assign a determined combination to the area;
determine a beam search direction according to the determined combination assigned to the area;
calculate a weight value for beam search data according to the beam search direction;
perform a weight application with respect to the beam search data with the weight value;
convert the weighted beam search data into the beam search signal in a wireless band; and
transmit the beam search signal to the another wireless communication apparatus via an antenna element.

9. The wireless communication apparatus according to claim 1, wherein the processor is further configured to:
receive feedback information indicating a result of a beam search by the beam search signal from the another wireless communication apparatus;
determine a direction of a communication beam based on the feedback information; and
perform a weight application with respect to communication data according to the communication beam direction,
wherein the processor transmits the weighted communication data to the another wireless communication apparatus.

10. The wireless communication apparatus according to claim 2,
wherein the wireless communication apparatus is a base station and the another wireless communication apparatus is a terminal device, or the wireless communication apparatus is a terminal device and the another wireless communication apparatus is a base station.

11. A wireless communication system comprising:
a first wireless communication apparatus configured to include a first memory and a first processor coupled to the first memory and the first processor configured to:
determine a number of transmissions of beam search signal for performing a beam search in an area where the beam search is performed, and determine a combination of the area and a presence/absence of the beam search signal according to the determined number of transmissions of beam search signal, based on a number of areas where the beam search is performed and a number of beams formed in the area by a transmission time of the beam search signal by the wireless communication apparatus, and
generate the beam search signal to be transmitted to another wireless communication apparatus according to the determined combination; and
a second wireless communication apparatus configured to include a second memory and a second processor coupled to the second memory and the second processor configured to:
obtain the beam search signal generated by the first wireless communication apparatus,
perform the beam search based on the beam search signal obtained.

12. A beam search signal transmission method comprising:
determining a number of transmissions of beam search signal for performing a beam search in an area where the beam search is performed, and determine a combination of the area and a presence/absence of the beam search signal according to the determined number of transmissions of beam search signal, based on a number of areas where the beam search is performed and a number of beams formed in the area by a transmission time of the beam search signal by the wireless communication apparatus; and
generating the beam search signal to be transmitted to another wireless communication apparatus according to the determined combination, by a processor.
